(19) United States
(12) Patent Application Publication
(10) Pub. No.: US 2006/0250603 A1
(43) Pub. Date: Nov. 9, 2006

(54) Multisite multichannel game tracker or game monitor

(75) Inventors: Timothy Scott Dawson, Edmore, MI (US); Timothy Lee Caudill, Fenton, MI (US)

Correspondence Address: Tim Dawson, 4140 Cornell, Dearborn Heights, MI, 48125, US

(73) Assignees: Timothy S. Dawson, Dearborn Heights, MI (US); Timothy Lee Caudill

(21) Appl. No.: 11/111,075

(22) Filed: Apr. 21, 2005

(51) Int. Cl. G01C 11/12

(52) U.S. Cl. 356/2

(57) ABSTRACT

This game monitor product is designed to give the hunter a independent audio and visual position or early warning of the deer or game animal as it comes or goes in or out the hunter's hunting range and possibly being out of sight. This is new in the art and field of hunting. The game monitor product can give advance audio and visual indication of deer or other moving game to a hunter. The game monitor product may also be used for advanced indication of competitors in games such as paintball and hide and seek based games applications. This is new in the art and field of paintball and hide and seek games applications. The game monitor product can also supply an optional output for tracking deer, game or prey to an application such as spreadsheets or log files.

### REFERENCE TO RELATED APPLICATIONS

May include hunting applications of motion detection, paintball and hide and seek game applications using motion detection and security type devices for the visual and audible detection for zoning of motion through infrared motion detectors for hunting, paintball, or hide and seek type games using transmission of signals through waveforms and audible circuits defined within potential Federal Communications (FCC) public domain bands on frequencies within obtainable ranges of public bands Per FCC, Code of Federal Regulations (CFR) above includes any combinations of frequencies That may be used for transmission, receiving, encoding and/or decoding for the purpose of the game monitor product. Tracking applications for plotting movement of game or prey, game tracker, game monitor.

### SPONSORED RESEARCH/DEVELOPMENT

None

### REFERENCE TO A SEQUENCE LISTING

The total number of compact disc including duplicates and the files on each compact disc shall be specified. None. Computer program listing in Appendix A (less than 300 lines).

### BACKGROUND OF THE INVENTION

The field of endeavor to which the invention pertains is hunting, paintball, and hide and seek game applications. Hunting, Design, General D22. Sport Equipment, Sport Equipment, 273. Additional applicable U.S. patent Classification Definitions are towards Hunting, Game, Tracker, and Monitor. Additional related classifications may include Design, Detector, Traffic Control, Transmission, Radio, Receiver, Recording and Recorders, Registers. Potential sub category listings in Appendix B. Only game tracking cameras are currently available within the hunting market and a single channel TV through catalogs. Cameras are not useful as an alert for the presence of competitors, game or prey in the field or hunting, paintball, or hide and seek game applications, just before competitor, game or prey may approach. Other applications for monitoring, gridding, triangulation, logging or spreadsheet programs for data acquisition of competitors, game or prey is not available.

### BRIEF SUMMARY OF THE INVENTION

This game monitor product is designed to give the hunter a position or early independent audio and visual indication of deer, game, or prey as it comes or goes in or out the hunter's hunting range and possibly being out of sight. This is new in the art and field of hunting. The product can give advance audible, and visual indication of deer or other moving game to a hunter along with optional output towards plotting, gridding and/or triangulation of inputs. This is new in the art and field of hunting. The product may also be used for advanced independent audio and visual indication of competitors in games such as paintball and hide and seek based games applications. Motion is detected by the use of wireless motion detectors sending a signal to a receiving monitor device on multiple channels. This is new in the art and field of paintball hide and seek game applications.

The standard package will consist of three or more signal transmitting motion detectors sending individual signals to individual receivers that in turn send out an audible signal to a stereo audio jack. The audio signals will signal the left speaker for channel one, right speaker for channel 3, and both speakers for channel 2. Individual signals will illuminate a specific zone lamp or LED with it's respective channel. Additional channels will be available for options with different audible pitches or frequencies and different encoding or frequencies to separate the additional channels. The application can also be incorporated into an optional computer based application as an input to be gridded out within an application, create triangulation, or mapping inputs over a time period. The package may incorporate serial, parallel, USB, firewire, bluetooth, or other known compatible outputs for the use in triangulation, plotting and or griddling of signals for use with common GPS, computer systems, or portable devices, similar to palm pilot® for monitoring output. Signaled outputs from the receiver will toggle specific bits high, low, or floating to serve as inputs to an external computer system and or asynchronous signals. The package may be available with 1, 2, 3, 4, or additional optional motion detectors and receivers for up to 64 zones. The receiver components to contain:
Receiver housing for the following components:
   1,2,3,4, or more indicator lamps
   1 audio jack (stereo)
   Circuit board(s) (circuit board to hold receiving circuits wiring and components to receive, decode, and trip specific zone lamps being LED or other and headphone audio circuit matching receiving transmitter signals matching frequency(s) and/or encoding.
   Optional strap, mount or high intensity led light provisions. The high intensity LED option will have all components mounted in a 6 volt lantern(flashlight) case with all LED's, audio jack, switch and optional port mounted in flat lens cover area panel. This can replace flashlights commonly carried a field.
   Power pack (Battery)
   Optional provision to Input/Output card for common standards as USB, IEE, serial, firewire, bluetooth, or parallel port input and mapping to computer program
   Optional provision to trigger outputs to alternate FCC approved public bands from 1 Hz to 2.3 GHz bands towards transmitting/receiving signals.
   Audible signals removed from speaker and modified for stereo headphones to eliminate potential sound to others, or game/prey animals and differentiate channel signals.
      Transmitters, 1 or more, have the following features:
Each signal (from wireless infared motion detector) sending an individual signal to the receiver (weather proof in nature)
Mounted approximately 3-5 feet high with optional strap provision.
Individual power pack (battery)
Transmits on matching frequency and or encoding to one of the receiver's channels. Transmitter and receiver frequencies can be modified with capacitors and coils, crystals, and/or dip switchable frequency generators while path is being breached by deer or other moving object for early detection of game or prey.

### BRIEF DESCRIPTION OF THE SEVERAL VIEWS OF THE DRAWINGS (e)

FIG. 1: Standard receiver housing. Hole locations defined. Used to house receiver boards, audio circuitry, power supply, stereo audio jack, and channel indicator LED's or lamps as described in detailed description.

FIG. 2: Transmitter housing modifications as described in detailed description.

FIG. 3: Stereo headphone audio circuit modifications as described in detailed description.

FIG. 4: Transmitter Logic (1 or more). Transmits on matching frequency to one of the receiver's channels as described in detailed description.

FIG. 5: Transmitter encoder circuitry block diagram. Common encoding block diagram to be modified for multiple channels as described in detailed description.

FIG. 6: PT2260 Pin configuration recommendation. To be modified for multiple channels as described in detailed description.

FIG. 7: PT2260 address data bit waveform. To demonstrate common transmission data bit format used for multiple channels as described in detailed description.

FIG. 8: Alternate transmitter circuitry A. To demonstrate one of many common transmission circuits that can be used as described in detailed description.

FIG. 9: Alternate transmitter circuitry B. To demonstrate one of many common transmission circuits that can be used as described in detailed description.

FIG. 10: Encoder operation flowchart. To demonstrate momentary vs. latched operation as described in detailed description.

FIG. 11: A/D bit modifications for receiver circuitry. To demonstrate opening of circuits to float circuits thus altering address code matching transmitter as described in detailed description.

FIG. 12: Oscillator frequency modification A with resistor. To demonstrate alternate common method to modify frequencies to transmit signal as described in detailed description.

FIG. 13: Receiver decoder circuitry block diagram. To show basic operation of known decoder operation as described in detailed description.

FIG. 14: PT2270 address data bit waveform. To address common receiver data bit formats used as described in detailed description.

FIG. 15: Alternate receiver circuitry A. To demonstrate one of many common receiver circuits that can be used as described in detailed description.

FIG. 16: Alternate receiver circuitry B. To demonstrate one of many common receiver circuits that can be used as described in detailed description.

FIG. 17: Decoder operation flowchart. To demonstrate and output states as described in detailed description.

FIG. 18: Typical 2670 receiver circuitry. This figure demonstrates bit modification area of decoder and antenna location notes as described in detailed description.

FIG. 19: Oscillator frequency modification A with resistor. Demonstrates alternate method to modify frequencies to transmit signal as described in detailed description.

FIG. 20: Example optional output. Example of common output for use in triangulation, gridding, or plotting functions of the game monitor output(s) as described in the detailed description.

### DETAILED DESCRIPTION OF THE INVENTION

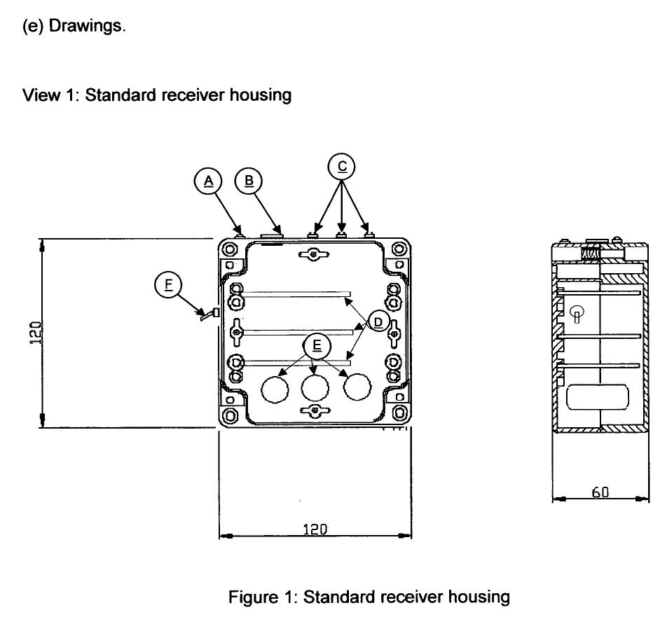

The manner and process of making and using the game monitor product is to use off the shelf transmitters and receivers. FIG. 1 shows a standard receiver housing that will incorporate three receiver circuit boards and related parts. FIG. 1 shows a typical housing layout to house the receiver circuit boards corresponding to specific channels, stereo output jack, power supply, LEDs, power switch, and antennas. The receiver housing will receive holes for the following parts:
FIG. 1, at A a 6 mm hole for 1 audio jack (stereo)
FIG. 1, at B a 16.5 mm×8.5 mm square hole with two 2.75 mm holes 12.5 mm from center of square hole (25 mm on center) for serial port option. The square hole may be located slightly above or below the mating line of the housing mating surfaces to aid process to cut square hole.
FIG. 1, at C three 6 mm holes 20 mm on center for LEDs near top center to right side of lower housing
FIG. 1, at F a 6 mm hole for power switch on left upper housing.

Receiver housing will hold receiving circuit boards shown in FIG. 1 at D and power supply shown at E. The receivers, antenna, wiring, and components to trip specific zone lamp(s) or LED(s) and headphone audio signals will be wired and assembled after other circuit modifications. The receiver boards, antennas, and power supply (shown at FIG. 1, E) are hot glued in place with antenna glued away from other circuits on final assembly. Optional strap provisions requires additional hole. Optional provision to mount In/Out (IO) card and port (USB, IEEE, firewire, parallel port or other receiver output) for computer program may be incorporated with card glued in place between top receiver card and hole modified for different port configuration measurement.

The receiver housing may include optional room for carrying transmitters and/or optional external power supply input jack for external power.

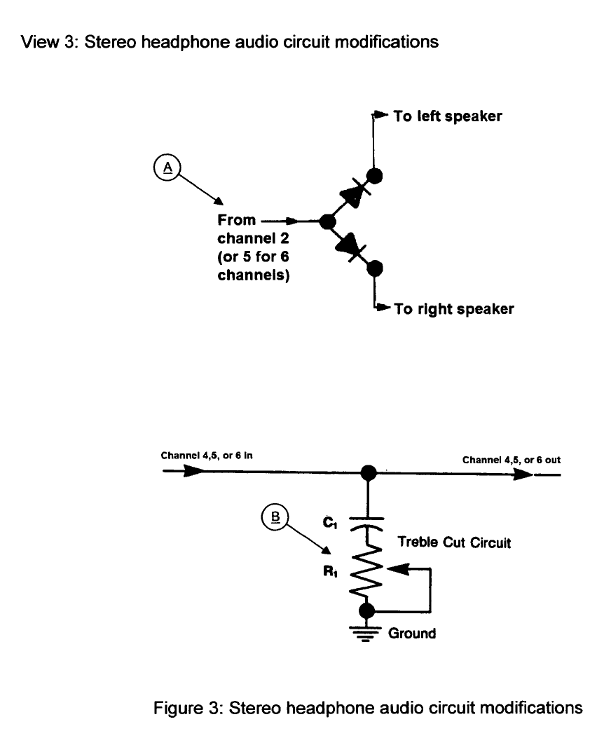

FIG. 3 shows the modification to isolate the receiver audio channels for stereo headphone jack that will incorporate left speaker to channel 1, right speaker to channel 3, and both channels to channel 2. Original receivers are disassembled, if shipped completed and speaker wires cut near speaker for audio modifications to be performed. Diodes are installed as shown at A of FIG. 3 for channel 2, and 5,8,11 and every second channel used in sets of three receivers, for audio signals, which is new in early detection of game or prey. Additional frequency modification will occur for additional channels (4-6, 7-9, 10-12, etc.) to change the pitch heard through the headphones is shown by using a simple treble cut tone control circuit as shown at B in FIG. 3, for additional channels above three. Additional channels may also incorporate high or low pass filters to block unwanted frequencies, dependent on the number of channels. Channel 1 is assigned and soldered to left speaker audio jack, channel 2 to both left and right speaker jacks (after installing diodes), and channel 3 to right speaker jack. Additional channels (4-6,7-9,etc.) wired to the same speaker jacks after treble control circuits (or filter) is installed in series for channels above 3. Audio grounds are all tied together for a single ground to the audio jack. Channel 5,8,11,14, etc. will also require diodes like channel 3.

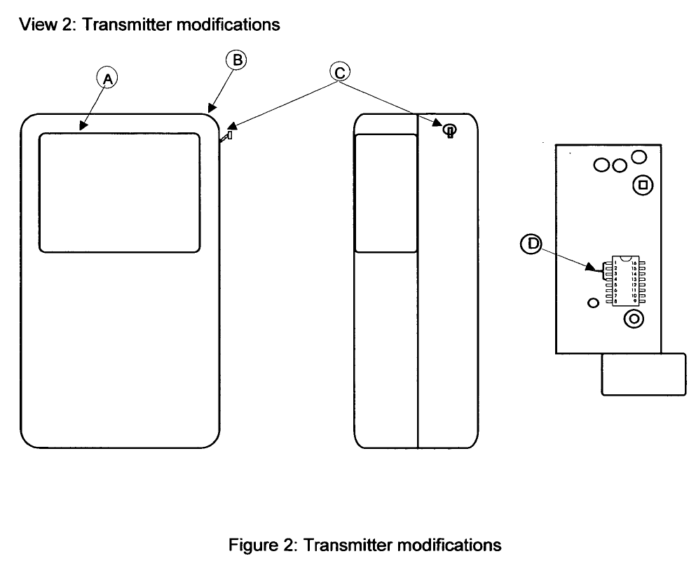

FIG. 2 shows transmitter modifications that will occur. FIG. 2, A shows the motion detector window that will have masking tape or cover installed for painting, if necessary, in a camouflage, or dull/satin green color. FIG. 2, B demonstrates screw location common on each corner of transmitter that will need to be removed to access the chip to be modified internally and explained in detail later in the detailed description. FIG. 2, C demonstrates the 6 mm hole location for an optional power switch to the transmitter, with the switch wired in series to the original battery positive (red) lead and terminating back to circuit board power. FIG. 2, D shows the location of the 2660 IC chip pins on circuit board that will be opened for this example and explained in detail to separate audio and visual signals for advanced indication of game or prey.

Each signal (from wireless infrared motion detector) sends an individual signal to individual receivers. Transmitter and receiver frequencies can be modified with capacitors and coils, crystals, resistors and/or dip switchable frequency generators to generate signal from transmitter to receiver while path is being breached by game or prey, or other game competitor moving object new in the field of hunting and paintball applications. The transmitters and receivers will be disassembled, unless manufacturing arrangement is made for receiving disassembled, then modifying the transmission frequency or encoding signals of each. Signals can be modified in different ways as needed, Either a capacitor and coil in common trap or tank circuits, crystal replacement, IC chip installation, dip switchable circuitry to allow selection of frequency or bit encoding. This example will demonstrate opening (to ground), opening (to float), or high signaling specific address bits, with floating specific bits to alter transmitters/receivers for multiple channels used in the example. The multiple channels are new for early audio, digital output, and visual detection of game or prey. The modified transmitted frequency(s) or address bit(s) are matched to the receiver channels for filtering the correct frequency(s) or decoding the correct address bits for each matching channel received. This example will use a PTC IC CMOS chip or PT2270 remote control decoder paired with PT2260 decoder utilizing CMOS Technology as an example. It has 12 bits off tri-state address pins providing a maximum of 531,441 codes or 312 address codes; thereby drastically reducing any code collision and unauthorized code scanning possibilities. Other alternatives will be briefly described to show that the patentable invention to separate signals, new for advanced indication of game or prey, or digital output in hunting, paintball or other hide and seek game applications, can be built with other components as well.

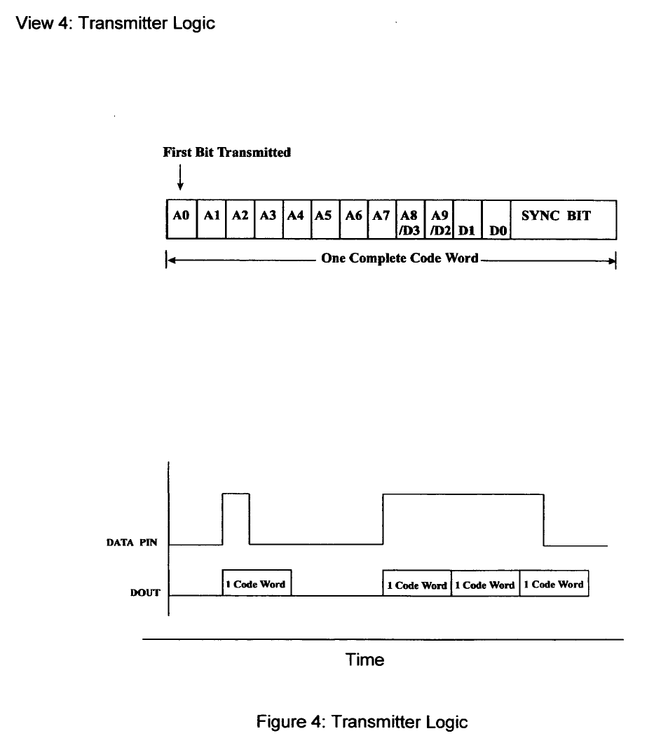

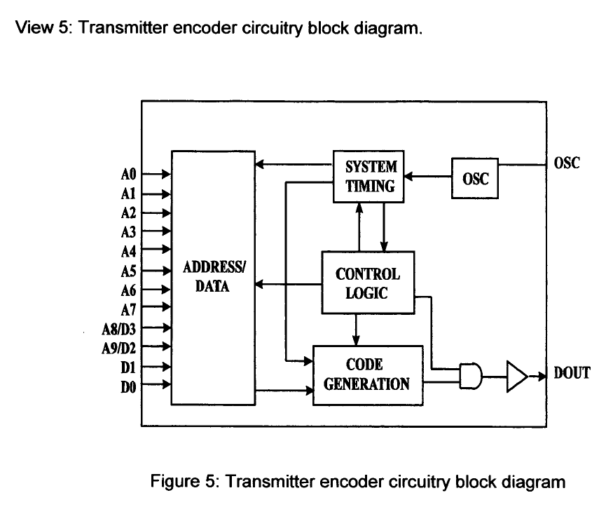

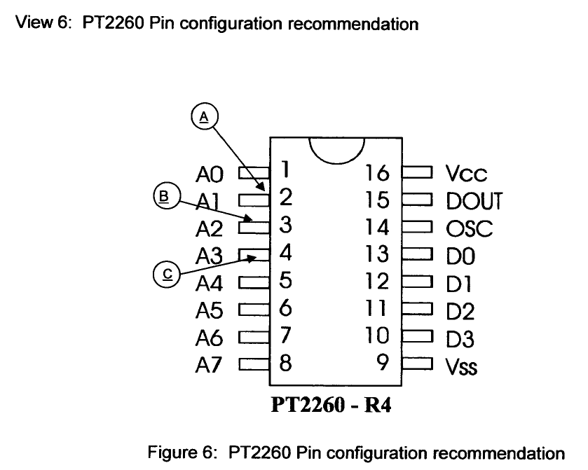

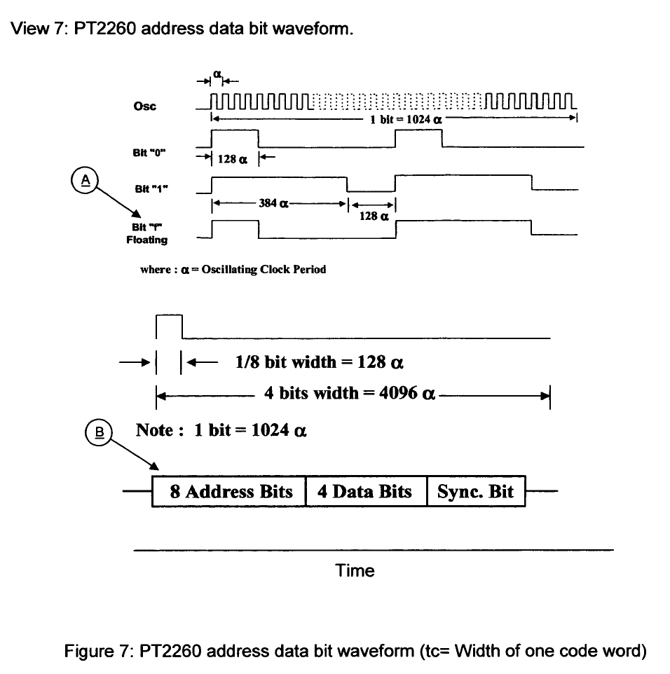

FIG. 4 represents the transmitter logic when a common motion detector signals high producing a code word. FIG. 5 demonstrates the transmitter encoder circuitry block diagram, with which the encoder uses in developing the frequency oscillation and assigning channels for the transmitter to send a matching signal to that of the receiver. FIG. 6, PT2260 Pin configuration recommendation, shows which pins, A, B, and C in FIG. 6 of the 2660 encoder are to be opened from the as manufacturer supplied boards received, to float each channel desired. It is recommended that pin number 1, 2, and 3 be opened (floated) for transmission on channels 2, 3 and 4 respectively. Code Address Pin Nos. 0-7 are eight tri-state pins detected by PT 2260 to determine the encoded wave form bit 0-bit 7, as shown in FIG. 6 (A0-A7) new for indication of game or prey in hunting, paintball or other hide and seek game applications. FIG. 7, A, PT2260 address data bit waveform, shows a floating bit. FIG. 4, Transmitter Logic, showed the address layout of a complete code word and data pin out with bit states represented by A0-A9 pins which correspond to the specific addresses from pins 1,2, 3, and 4 mentioned earlier. Each bit can be set to 0, 1, or f(floating). FIG. 4 represents a modified floating bit at A, and the corresponding output of the code word with address bits, data bits, and sync bit output of a code word. Modification is to be performed to open, float or voltage apply on the pins to set address, with opening (removing foil circuit by scraping to pins or 2660) to float pin recommended, shown in FIG. 6, PT2260 Pin configuration recommendation, A, B and C. The oscillator of the 2660 may also be modified, by inserting a specific resistor between Osc and Vcc pins to change frequencies if additional channel capacity is needed which is new in early detection of game or prey. Resistor values will be cover later in detailed description.

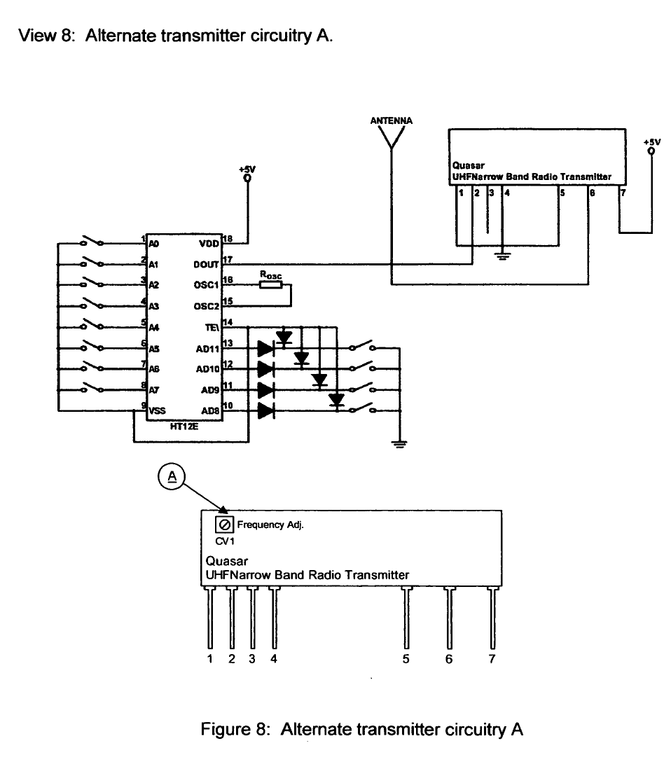

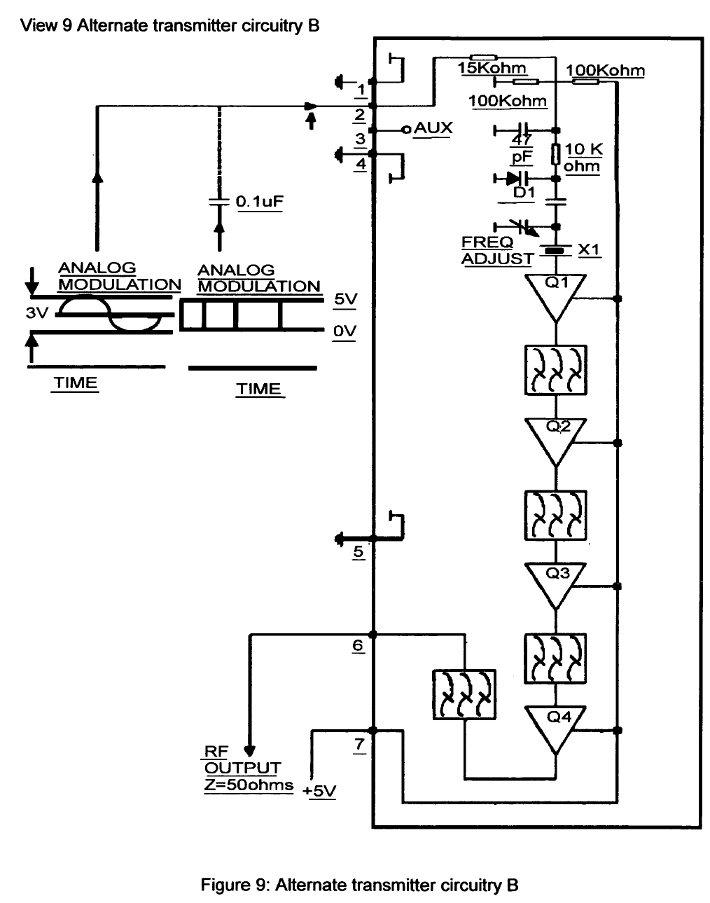

FIG. 8, Alternate transmitter circuitry A, demonstrates an alternative UHF narrowband transmitter that could be used as a replacement component for the 2660. The UHF narrowband transmitter also has settable bits and frequency adjustment at FIG. 8, A, to obtain narrow bands of operation to separate channels by 50 Khz channel spacing and will also operate in the 433 to 434 Mhz range. FIG. 9, Alternate transmitter circuitry B, at callout A, demonstrates the common super-het logic incorporated in the transmitter and the analog output at 1 that could also be modified for the separate channels which is new to give advance warning or track game or prey hunting or paintball applications.

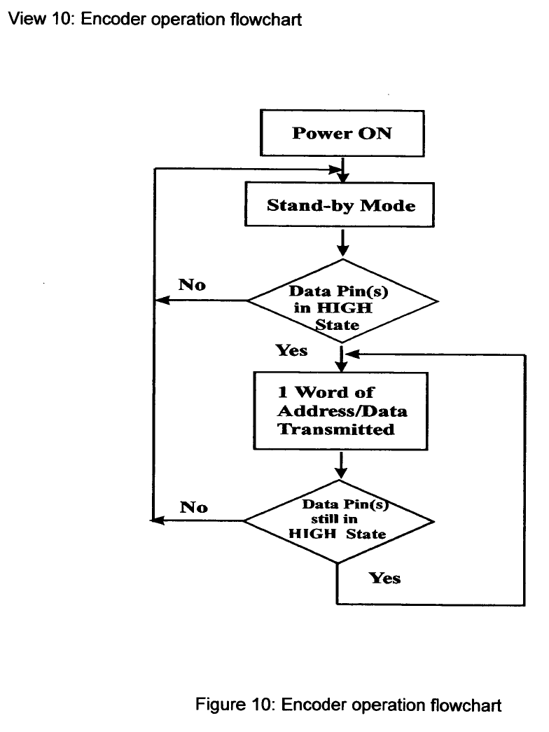

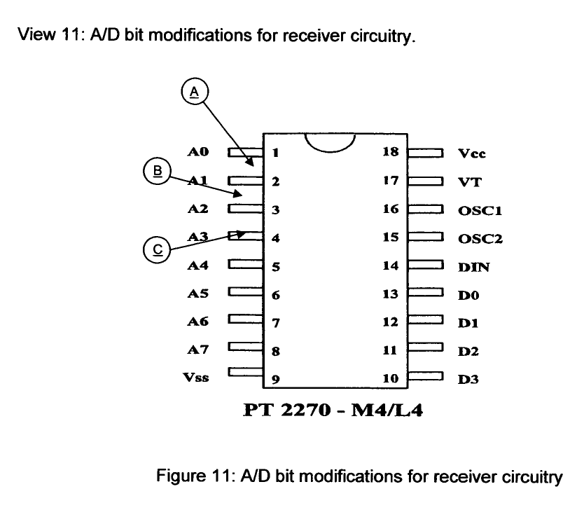

FIG. 10, Encoder operation flowchart, demonstrates the high output as long as the motion detector circuit triggers high, detecting game or prey setting data pin high. The encoder operation flowchart demonstrates that transmission will continue as long as this data pin is high. If the pin goes low, transmission stops and the encoder is preset to non-latching. FIG. 11, A/D bit modifications for receiver circuitry, demonstrates the modifications for receiver 2670 circuitry that are the same as described for the transmitter 2660 for early indication of game or prey. Open pin 1,2, and 3 for channels 1,2, and 3 to be assigned floating addresses, shown at A,B, and C. Other addresses are available, just like the transmitters by choosing matching grounded, open, or floating states of the first pins which is new to give advance warning or track game or prey hunting or paintball applications. The receiver decoder is then modified, by removing existing led circuitry, installing jumper wires to wire the correct output high that toggle the correct LED for it's assigned channel. The housing was drilled as described earlier to mount separate LED's for each of the three channels on the standard model and are then labeled 1, 2, or 3, etc., with stick on labels, for the correct channel assignments for early detection of game or prey. The audio output circuit is also modified at this time by inserting 2K ohm resistors on each receivers audio output leads, including channel 2. Channel 2 leads, have diodes installed (strip towards board output) to isolate other channels as shown in FIG. 3, Stereo headphone audio circuit modifications, at A. After diodes and resistors are soldered each channel is soldered to stereo audio output jack inputs as described earlier. This is new to give advance audio warning to track game or prey hunting or paintball applications. Optional channels above three will receive additional modification as shown in FIG. 3, treble cut circuit, for alternate pitch by modifying frequency outputs to frequencies other than the first three channels. Channels 7 through 9 will receive additional modification to alter audible output to higher or lower frequencies than the proceeding channels by changing resistance levels. Channels above 9 will receive similar modification in the audible ranges.

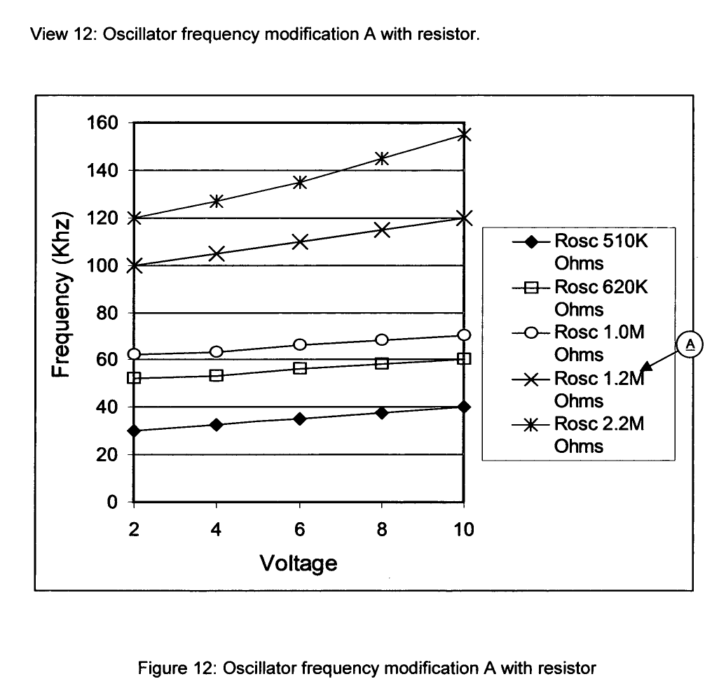

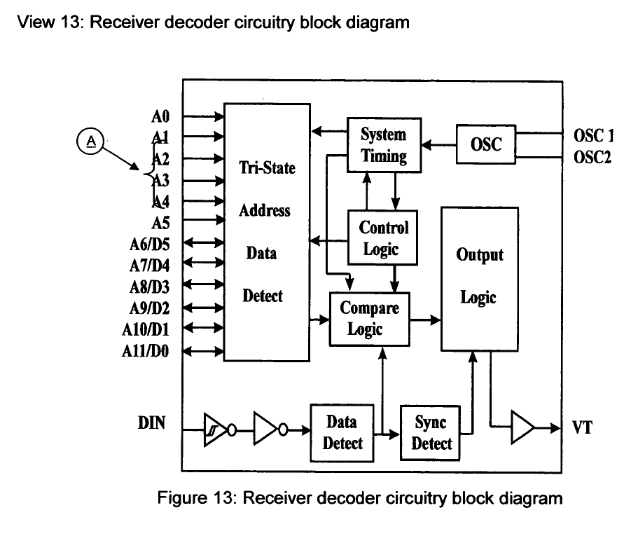

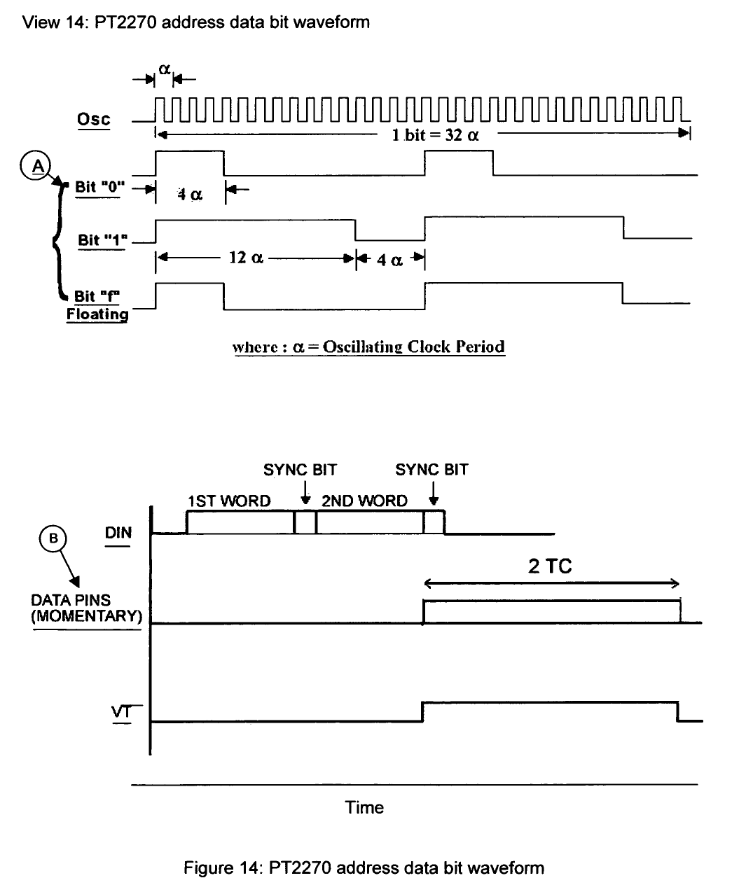

FIG. 12, Oscillator frequency modification A with resistor, shows resistor level changes, if additional frequencies are required. Matching resistors for the receiver must be ⅗ths the value of the transmitter to modify kHz bands of encoder/decoder oscillator frequencies. FIG. 12, A shows 1.2M ohm that would reqire 2M ohm on the transmitter circuit for matching frequencies. This demonstrates an alternative circuit for advance warning or tracking of game or prey for hunting or paintball applications. The oscillator frequency modification A with resistor frequencies to be within FCC, non license required bands, or optional owner licensable bands, with license application instructions included for any licensable bands produced. FIG. 13, Receiver decoder circuitry block diagram, with A representing the modified address(s). FIG. 14, PT2270 address data bit waveform, shows the PT2270 address data bit waveform at A and the momentary output that resets low after the transmitter has completed detecting game or prey at B. This is new to give advance warning or tracking of game or prey for hunting or paintball applications.

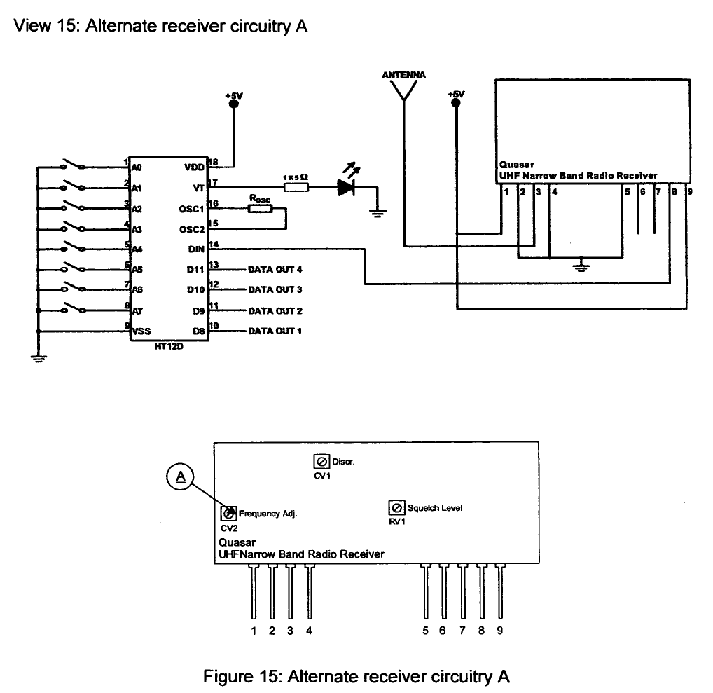

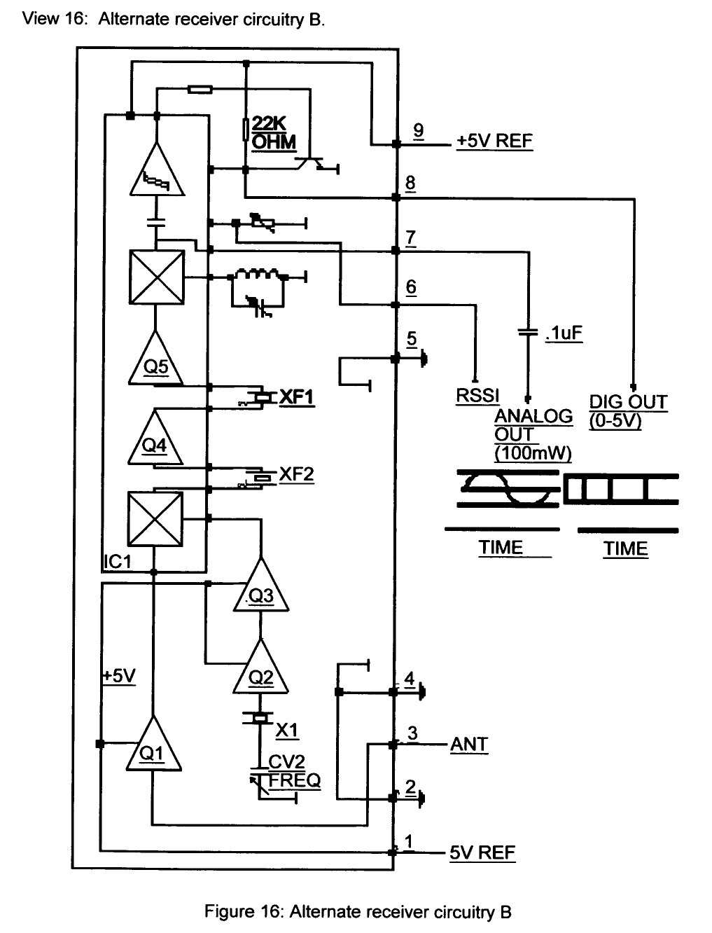

FIG. 15, Alternate receiver circuitry A, represents an alternate receiver circuitry demonstrated for the transmitter. Callout A demonstrates potentiomenter for frequency adjustments to bands are also available like the transmitter. FIG. 16, Alternate receiver circuitry B, shows the analog and digital outputs that can be altered like the transmitter described previously. This demonstrates an alternative circuit for advance warning or tracking of game or prey for hunting or paintball applications.

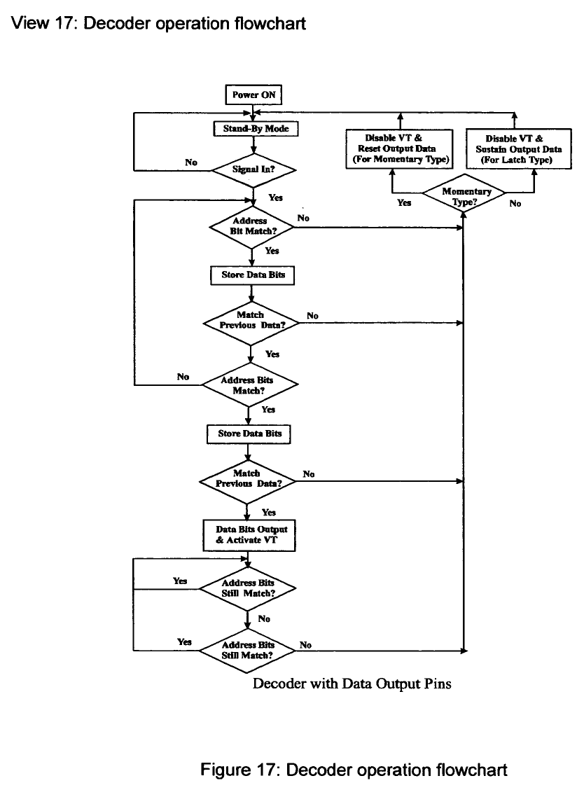

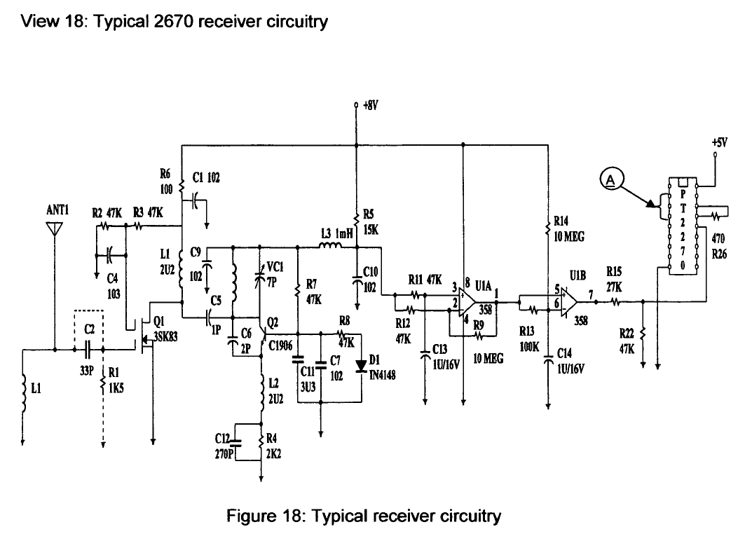

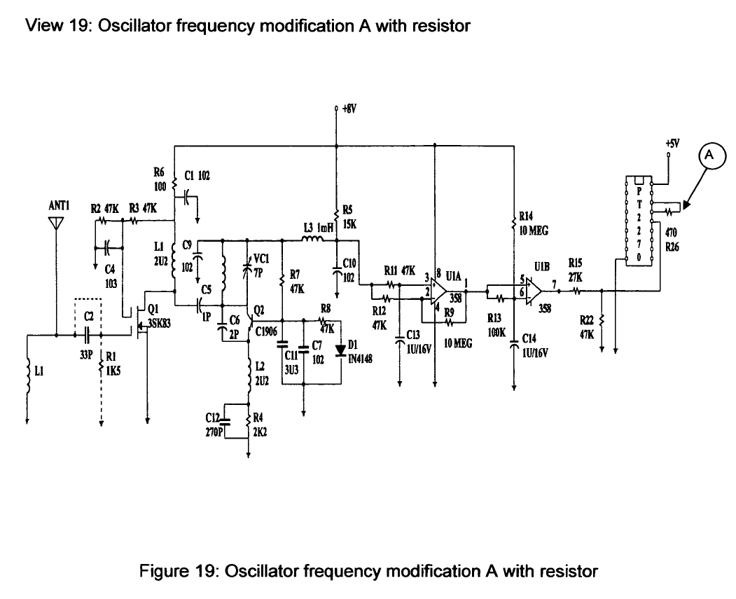

FIG. 17, Decoder operation flowchart, demonstrates the decoder operation flowchart for the 2670 and FIG. 18, Typical receiver circuitry, demonstrates typical receiver circuitry and area of modification for address at A, required for modification, for advance warning or tracking of game or prey for hunting or paintball applications. The antennas from each receiver circuit must not be placed across other circuitry to eliminate potential interference. FIG. 19, Oscillator frequency modification A with resistor shows the location of oscillator frequency modification A with resistor at A, if required for additional channels for early indication of game or prey on additional channels. Resistor values were explained in the FIG. 12 details earlier. For frequency changes on the MHz bands, the antenna will need to be trimmed or extended proportionally to any new frequency, if selected, transmitted on any other than the 433-435 MHz range.

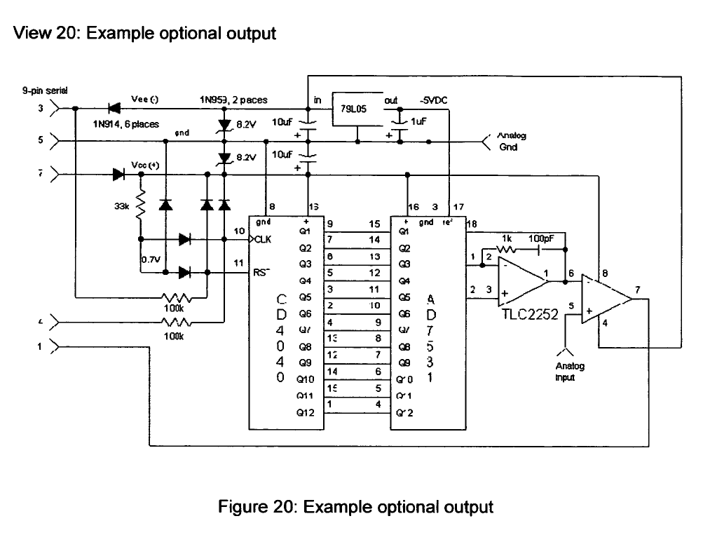

FIG. 20 represents an example optional output to obtain a serial output to a computer. The circuitry will be duplicated for additional channels and assigned separate serial pin addresses. Other circuits may also be incorporated for additional output type to adapt to parallel, USB, firewire, etc. as needed for plotting, gridding and/or triangulation of game or prey for hunting, paintball, or other hide and seek type games. FIG. 20 demonstrate a basic circuit for obtaining serial output. A simple circuit connects to a serial port and a short Qbasic, basic or other program gathers and saves 12 bit data to a file. A spreadsheet automatically retrieves the file and displays the data in real time. An example program is listed in appendix A. The output may be plotted over time and recorded to various spreadsheets and/or log files for later viewing, if desired. The output is new to the early detection, plotting, gridding, and/or triangulation of game or prey.

For final assembly, the three receivers are located in the receiver housing with hot gluing, with power supply (3 c cells) hooked up and serial port from serial port outputs shown in FIG. 20 (other port option, USB, parallel, firewire, bluetooth etc,), jumper installed from LED to serial port card input, and installed in housing, depending on options. The housing optional brackets, or mount are installed, and the power switch wired in series to the power supply and receivers. The original power supplied battery connectors will be removed and paralleled to a common on/off switch, battery supply and ground lengthened to relocate receiver's batteries within the housing as necessary. The receiver unit will then be reassembled into the housing with connecting the led inputs, power switch, and ground along with the audio jack mounting to housing, circuit boards and antenna hot glued within housing. The transmitter housings will then be painted to a green or camouflage color combination, if injection molding of green is unavailable. An optional power switch may be installed in transmitters, but antenna wire cannot come in close proximity to power wires and will loop back, instead of cross power leads if power switch is wired in series to battery connector positive and circuit board. Hot glue antenna wire in a couple areas. The transmitters will then be reassembled. The Owners Manual will be printed and the contents packaged in a cardboard box with stick-able label attached packing peanuts inserted, and the box taped.

The manner and process of using the game monitor product can give advance indication of deer or other moving game to a hunter. The product may also be used for advanced indication of competitors in games such as paintball and hide and seek based games applications. Motion is detected by the use of wireless motion detectors sending a signal to a receiving monitor device. The game monitor product is used by placing the correct batteries three C's in receiver and 9 volt within the transmitters and receiver by removing the transmitter cover and placing batteries in with proper polarity (+ to +) and (− to −). Rechargeable batteries are recommended if the units are used a lot. The hunter would place the transmitters within 20 feet of a known game runway with the transmitter unit approximately three feet above the ground, sensor cover facing runway. Placing less than two feet from the ground can lead to the detector picking up smaller game animals. The transmitters shall be placed within 400 feet of the receiver and should be placed proportionally closer if cover is present between the transmitters and receiver. Try to minimize cover between transmitter and receiver paths. The hunter should use care in trying not to leave scent while placing transmitters that may be detected by game animals. The transmitters should be placed upwind if possible if game normally moves into the wind or the hunter is normally facing the most likely direction game originates from. Do not excessively touch objects near the transmitter or on the paths used to place transmitters which can alert game or prey. Warning: Hunters are cautioned as to the use of the product can indicate the presence of humans and shall always recognize their target before aiming any weapon or discharging any firearm. Game monitor makes no warranty as to the use of this product either implied and/or not. The product is to be used as advance indication of game or prey only and only where applicable by state and local laws. Other uses are at the sole discretion and decision of the User. Transmitters shall be placed in the typical non-viewing direction of the hunter, where signs of use or tracks are present. Transmitters should be placed downwind of area to be monitored to lower any potential odors that can alert prey or game animal(s). They should not be placed in areas or close proximity to any houses or other where discharge direction of a firearm can result in a dangerous situation. The receiver should be held in ones lap, strapped around neck or placed to one side for viewing Light Emitting Diodes (LEDs). Caution: The receiver can become a hazard when climbing objects such as tree stands or other. Remove receiver from neck, if it may present any hazard while climbing and use a rope to retrieve if necessary. When on stand, turn receiver power on. When an LED lights and audible signal heard, look towards the transmitters corresponding direction for game animals. Batteries may last for a few days. If prolonged operation is required, and units not used for a period of days, it is recommended to remove the batteries from transmitters. For prolonged storage, remove the batteries from both transmitters and receiver. The best mode is to use as described above with audio earpiece or headphones to notify the hunter quickly without signaling any game in the near area. Look at the LED and scan the hunting region game shall be expected to enter or exit from. The specification points out and distinct modification of frequencies to specific channels or LEDs and removal of any loud audible signals to the general area that allow the game monitor product to suitably operate towards the invention purpose as claimed. Outputs from the transmitters or receiver may also have frequencies or digital outputs modified to match commonly available hardware with scanning capabilities using CB, scanner, GMRS, FRS, or frequency scannable devices depending on options selected. Options may also include input for common computers such as USB port, serial, parallel, firewire, bluetooth, laptop card, or handheld palm pilot® type device in a digital signal format (i.e. CAN, serial data, byte, etc.). The above modifications allow for the use in hunting applications sufficiently different from what has been used or described before that it may be said to be non-obvious to a person having ordinary skill in the area of technology related to the invention. The above modifications also allow for the use in paintball and hide and seek based games applications sufficiently different from what has been used or described before that it may be said to be non-obvious to a person having ordinary skill in the area of technology related to the invention. As described in summary and detailed specifications. Paintball applications shall not use neck strap while running or climbing or restrain from movement during those times. Laptop and or palm type based applications are also not recommended since damage to these types of equipment can occur from paintballs, running, or other. Improvements result from manufacturing towards multiple zones being able to be monitored without excess audible signals where hunting, paintball and hide and seek based applications can receive the same benefits. Always check local and state laws regarding usage of the device. Shareware and other programs are available to monitor data into computer systems, depending on options selected. The data for triggered inputs for applications may want to be set with a small window around high (tripped signal from game or prey) to improve resolution over long periods of time and adequately see triggered events by game or prey

1: This game monitor product, multisite multichannel game tracker or game monitor, is designed to give the hunter a position or early independent audio and visual indication of deer, game, or prey as it comes or goes in or out the hunter's hunting range and possibly being out of sight. This is new in the art and field of hunting. The product can give advance audible and visual indication of deer or other moving game to a hunter along with optional output towards plotting, gridding and/or triangulation of inputs. This is new in the art and field of hunting.
The subject matter sought to be patented is in the use for hunting applications is sufficiently different from what has been used or described before that it may be said to be non-obvious to a person having ordinary skill in the area of technology related to the invention.

2: The game monitor product, multisite multichannel game tracker or game monitor, may also be used for early or advanced independent audio and visual indication of competitors in games such as paintball and hide and seek based games applications. Motion is detected by the use of wireless motion detectors sending a signal to a receiving monitor device on multiple channels. This is new in the art and field of paintball hide and seek game applications.
The subject matter sought to be patented is in the use for paintball, and hide and seek games applications is sufficiently different from what has been used or described before that it may be said to be non-obvious to a person having ordinary skill in the area of technology related to the invention.
